(19) United States
(12) Patent Application Publication
(10) Pub. No.: US 2016/0026011 A1
(43) Pub. Date: Jan. 28, 2016

(54) PRESENTATION SYSTEM ENABLING ADJUSTABLE PHOTO TRANSMITTANCE AND MULTI-PLANE VISIBILITY

(71) Applicant: Pei-En LEE, Taipei City (TW)

(72) Inventors: Pei-En LEE, Taipei City (TW); Wei-Ting CHEN, Taipei City (TW); Chung-Chen CHEN, Taipei City (TW); Po-Chih CHANG, Taipei City (TW); Shih-Shin HUANG, Taipei City (TW); Hsiang-Lin TUAN, Taipei City (TW)

(21) Appl. No.: 14/806,316

(22) Filed: Jul. 22, 2015

(30) Foreign Application Priority Data
Jul. 22, 2014 (TW) 103213054

(51) Int. Cl. G02F 1/01; G02B 26/00

(52) U.S. Cl. CPC G02F 1/0102; G02B 26/004

(57) ABSTRACT

A presentation system enabling adjustable photo transmittance and multi-plane visibility is disclosed, comprising: at least three rendering mediums enabling the adjustable photo transmittance, in which such rendering mediums are mutually adjoined to constitute a multi-plane presentation medium group having an internal presentation space thereby allowing a presentation object to be placed therein for the purpose of object presentations. The implementations of the rendering medium may be selected to be one of the active rendering display component enabling adjustable photo transmittance or the passive rendering component, and the multi-plane presentation medium group may be applied in conjunction with a multi-media video/audio playing system to display the graphical and textual video/audio information of the object, and also in conjunction with a multi-media video/audio interactive system to form an interactive presentation system enabling adjustable photo transmittance and multi-plane visibility.

### BACKGROUND OF THE INVENTION

1. Field of the Invention

The present invention generally relates to a presentation system for an object; in particular, the present invention relates to a presentation system enabling adjustable photo transmittance and multi-plane visibility.

2. Description of Related Art

Conventionally, an object can be presented by means of static pictures or dynamic video/audio clips, which can be accomplished essentially through planar media, e.g., posters, billboards or outdoor television walls, to release advertisements, but such posters or billboards all have just one plane to display or exhibit merely a single side of the presentation object and are unable to show the graphical and textual video/audio information or images of the object in multiple planes. Meanwhile, by means of the television walls, it is possible to display the dynamic graphical and textual video/audio information or images of the object or even the images of the object in different planes, but only the people locating in front of the television wall can see the presentation contents of the object.

An “Improved Structure of Billboard” set forth in the approved R.O.C. Innovative Model Patent No. M261789 proposes a small-sized billboard which comprises multiple boards and allows a rotation feature thereby facilitating the handy carriage and convenient delivery operations. Moreover, an “Object Presentation System and Method” illustrated in the approved R.O.C. Inventive Patent No. I420440 proposes a type of object presentation system which operates on a control host, and the control host is connected to a columnar electronic billboard as well as an image input unit including at least three camera devices. In operation, the system analyzes the real-time scenery images taken by the above-said image input unit around the columnar electronic billboard thus detecting the occurrence of viewers around the columnar electronic billboard, and upon detecting the viewer, traces the location of the viewer and then, based on the viewer's location, selects an image of the presentation object photographed at a corresponding angle from the image database of the presentation object, thus displaying to the viewer on the area facing toward the viewer in the columnar electronic billboard.

The aforementioned two types of known technologies allow viewers located at different directions to watch the advertisements or the presentation object, but it is not possible to show the physical object, in particular the latter requires to operate in conjunction with several equipments or devices such as a control host, camera devices and image database etc. to present the object, undesirably causing the issues of complicated structures and relatively higher installation costs.

### SUMMARY OF THE INVENTION

The objective of the present invention is to provide a presentation system capable of presenting a physical object and/or the graphical and textual video/audio information of the object in a multi-plane fashion.

The present invention discloses a presentation system enabling adjustable photo transmittance and multi-plane visibility, suitable for presenting a physical object and/or the graphical and textual video/audio information of the object in a multi-plane fashion, comprising: at least three rendering mediums having the feature of adjustable photo transmittance, in which such rendering mediums are upright installed and mutually adjoined to constitute a multi-plane presentation medium group having an internal presentation space.

In a preferred embodiment, the multi-plane presentation medium group is of a polygonal columnar structure including plural rendering mediums enabling adjustable photo transmittance.

In a preferred embodiment, the multi-plane presentation medium group is of a polygonal tapered structure including plural rendering mediums enabling adjustable photo transmittance.

In a preferred embodiment, the rendering medium is an active rendering display component enabling adjustable photo transmittance.

In a preferred embodiment, the rendering medium is a passive rendering component. Herein, the passive rendering component can be selected to be any one of a combination of the glass and the adjustable photo transmittance material, a combination of the acrylic and the adjustable photo transmittance material as well as a combination of the plastic compound and the adjustable photo transmittance material. The adjustable photo transmittance material may be selected from the electrically conductive switchable transmittance film or the chemical dyestuff object.

In a preferred embodiment, a presentation platform can be included, which has a load plane for the placement of the object, and the load plane includes a fixation trough corresponding to the bottoms of such rendering mediums constituting the multi-plane presentation medium group, and the fixation trough allows the insertion of the bottom of the rendering medium so as to further facilitate such rendering mediums to be mutually adjoined thus forming the multi-plane presentation medium group.

In a preferred embodiment, such rendering mediums are mutually adjoined together by means of a connector installed at the adjoining portions between any two adjacent rendering mediums. The connector can be any one of the hinge as well as the pivot joint axle and the pivot joint seat thereof.

Other effects of the present invention as well as detailed illustrations for the embodiments will be set forth hereunder in conjunction with the appended drawings.

### BRIEF DESCRIPTION OF THE DRAWINGS

FIG. 1 shows a structural disassembly view for an embodiment according to the present invention.

FIG. 2 shows a structural assembly view for the embodiment in FIG. 1.

FIG. 3 shows a structural disassembly view for another embodiment according to the present invention.

FIG. 4 shows a structural assembly view for the embodiment in FIG. 3.

FIG. 5 shows a structural disassembly view for another embodiment according to the present invention.

FIG. 6 shows a structural assembly view for the embodiment in FIG. 5.

FIG. 7 shows an application diagram of the present invention.

### DETAILED DESCRIPTION OF THE PREFERRED EMBODIMENTS

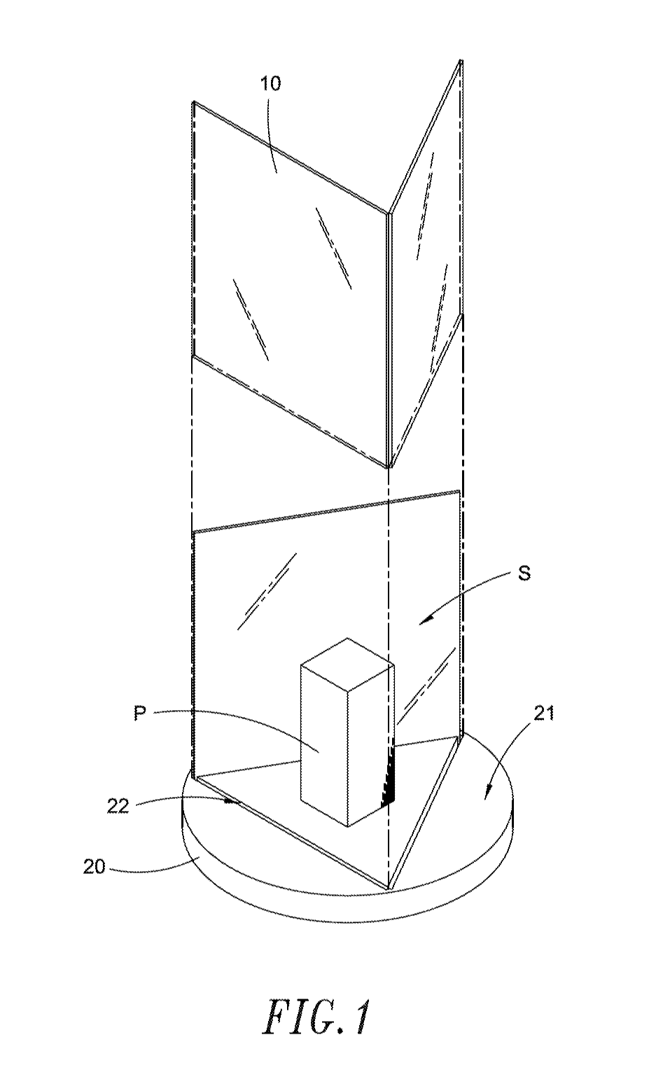

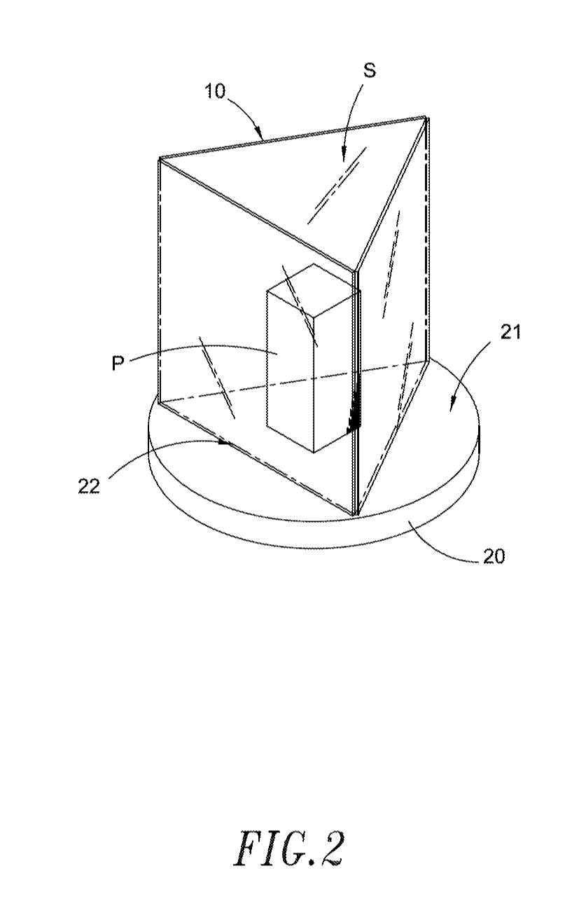

Initially, refer to FIGS. 1 and 2, wherein a structural disassembly view and a structural assembly view for an embodiment according to the present invention are respectively shown. Herein a presentation system enabling adjustable photo transmittance and multi-plane visibility according to the present invention is disclosed, comprising: at least three rendering mediums 10 enabling the adjustable photo transmittance, in which such rendering mediums 10 may be mutually adjoined to constitute a multi-plane presentation medium group having an internal presentation space S; one possible implementation may be characterized in that plural rendering mediums 10 are upright installed and mutually adjoined so as to form a columnar multi-plane presentation medium group thereby allowing the placement of a presentation object P in the internal presentation space S for the purpose of objection exhibitions. The rendering mediums 10 may be planar or curved.

In one embodiment of the present invention, there further includes a presentation platform 20 having a load plane 21 for the placement of the presentation object P, and the load plane 21 includes a fixation trough 22 corresponding to the bottoms of the rendering mediums 10 constituting the multi-plane presentation medium group, in which the fixation trough 22 allows the insertions by the bottoms of the rendering mediums 10 thus further letting such rendering mediums 10 be mutually adjoined to form a multi-plane presentation medium group including an internal presentation space S.

The selection for implementing the rendering mediums 10 may include any one of the active rendering display component enabling adjustable photo transmittance or the passive rendering component. The active rendering display component enabling adjustable photo transmittance can receive the graphical and textual video/audio information from a video/audio equipment, while the graphical and textual video/audio information displayed by the passive rendering component may come from a projector or any other photo-image generation devices.

The rendering medium 10 has a photo transmittance feature such that the contents presented by the rendering medium 10 are visible in both the forward and backward planes of the rendering medium 10. When the rendering medium 10 is not displaying the graphical and textual video/audio information, the viewer can see the presentation object P placed inside the internal presentation space S through the rendering medium 10; on other hand, when the rendering medium 10 is showing the graphical and textual video/audio information, the viewer can also synchronously watch the physical presentation object P via a transmitting area. A multi-plane presentation medium group composed of at least three rendering mediums may operate in conjunction with a multi-media video/audio playing system to display the graphical and textual video/audio information of the object and, for example, on a rendering medium 10 corresponding to a certain orientational plane of the presentation object P, show the graphical and textual video/audio information of the object in the corresponding orientational plane of the presentation object P. In another embodiment, it is further possible to apply the multi-plane presentation medium group composed of such rendering mediums 10 in conjunction with a multi-media video/audio interactive system as well as the touch-control technology, such as installing a touchscreen on the display plane of the rendering medium 10 such that it can present the graphical and textual video/audio information of the presentation object and also allow interactive operations by a user via the touch-control interface so as to enhance the advertisement effects for the object.

In addition, the passive rendering component can be selected to be any one of a combination of the glass and the adjustable photo transmittance material, a combination of the acrylic and the adjustable photo transmittance material as well as a combination of the plastic compound and the adjustable photo transmittance material. The adjustable photo transmittance material may be selected from the electrically conductive switchable transmittance film or the chemical dyestuff object. Herein the electrically conductive switchable transmittance film is a type of material or compound which enables photo transmittance adjustments by way of electrical controls.

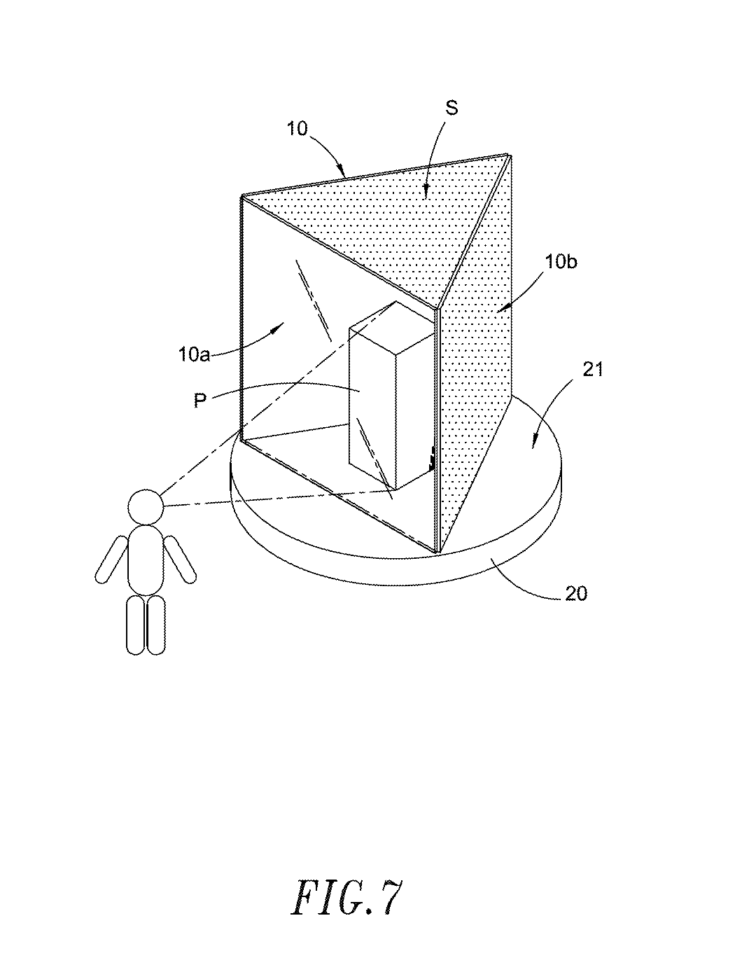

In the embodiment of FIG. 7, when a first rendering medium 10a is in a transmitting state, the viewer can see the presentation object P located inside the internal presentation space S as well as the graphical and textual video/audio information about the presentation object. Moreover, suppose a second rendering medium 10b is in a non-transmitting state, it can shield the image of the presentation object P on a corresponding plane, or alternatively, it is also possible to display the relevant graphical and textual video/audio information of the object on the non-transmitting second rendering medium 10b. Seeing that the multi-plane presentation medium group can operate conjunctively with the aforementioned multi-media video/audio playing system or the above-said multi-media video/audio interactive system to constitute an interactive presentation system enabling adjustable photo transmittance and multi-plane visibility, it is possible to implement the simultaneous presentation or switchable presentation functions for the physical object presentation as well as the graphical and textual video/audio information of the object thus further facilitating various object presentation fashions.

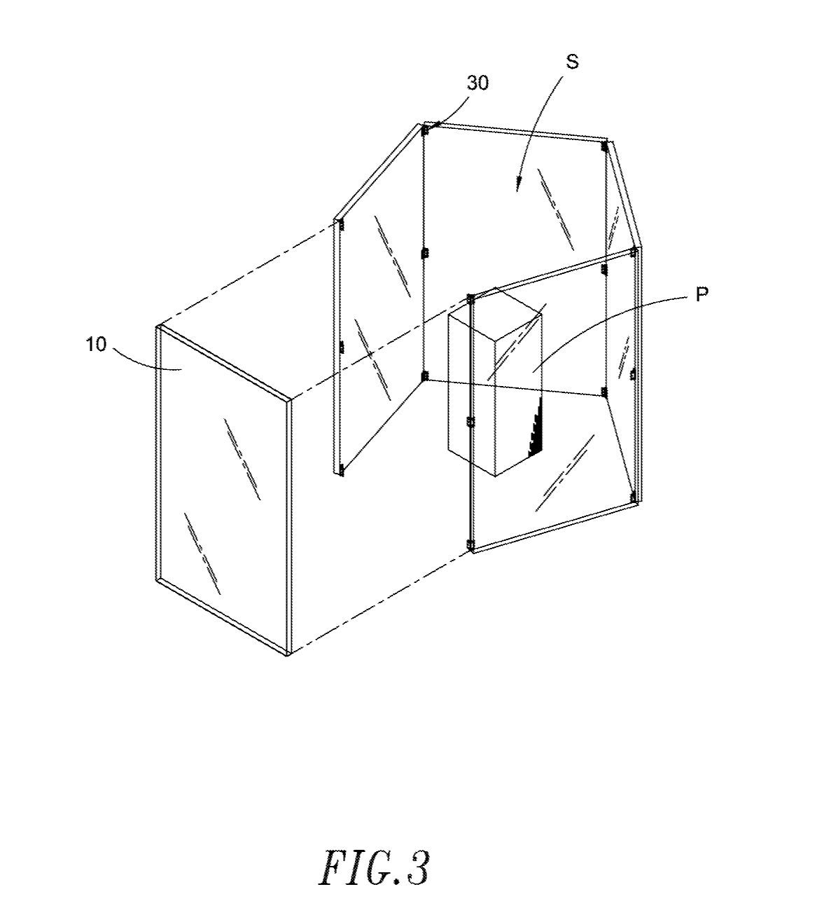

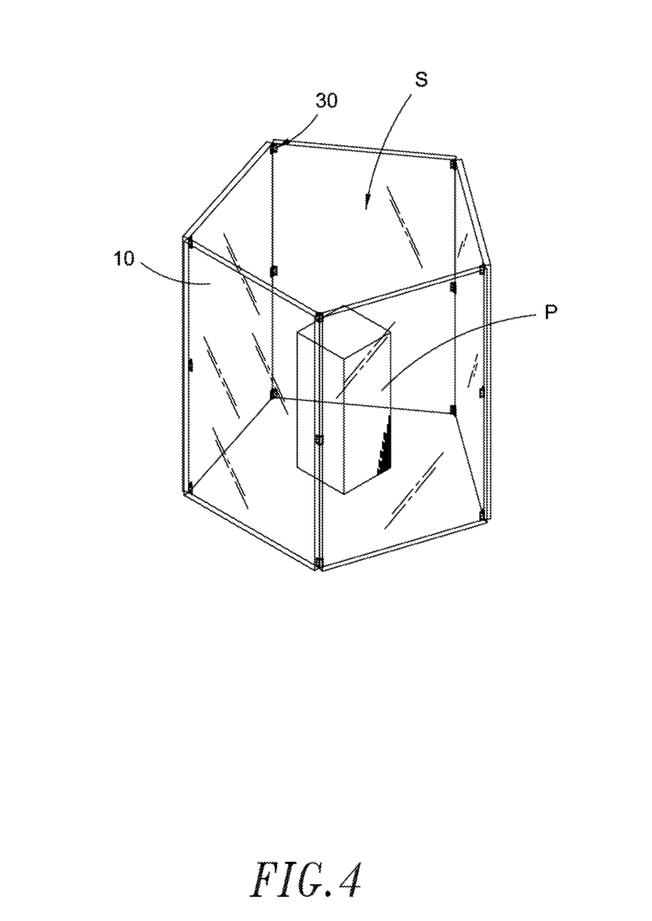

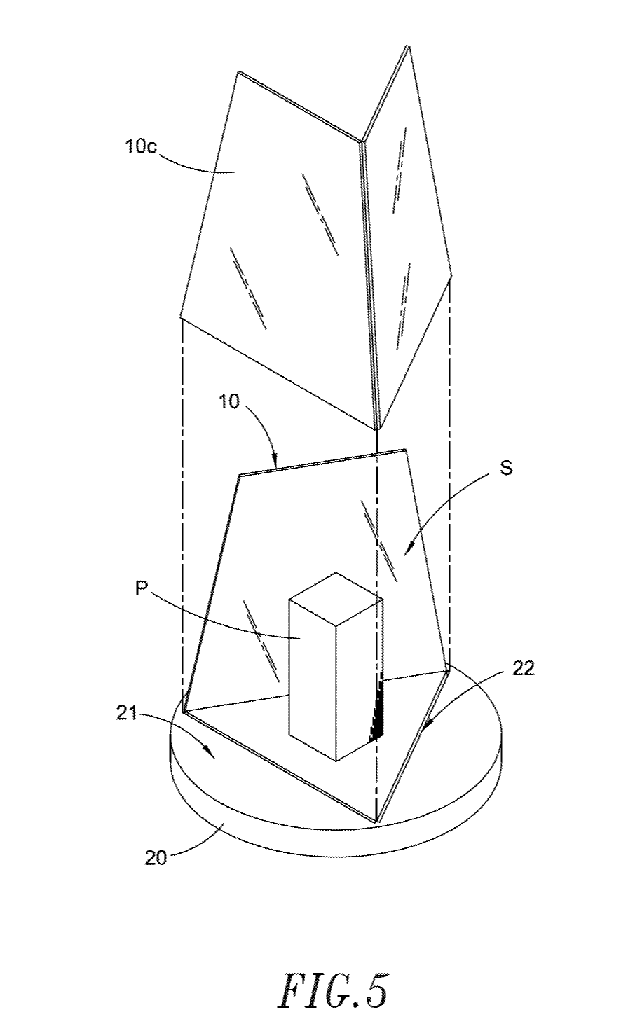

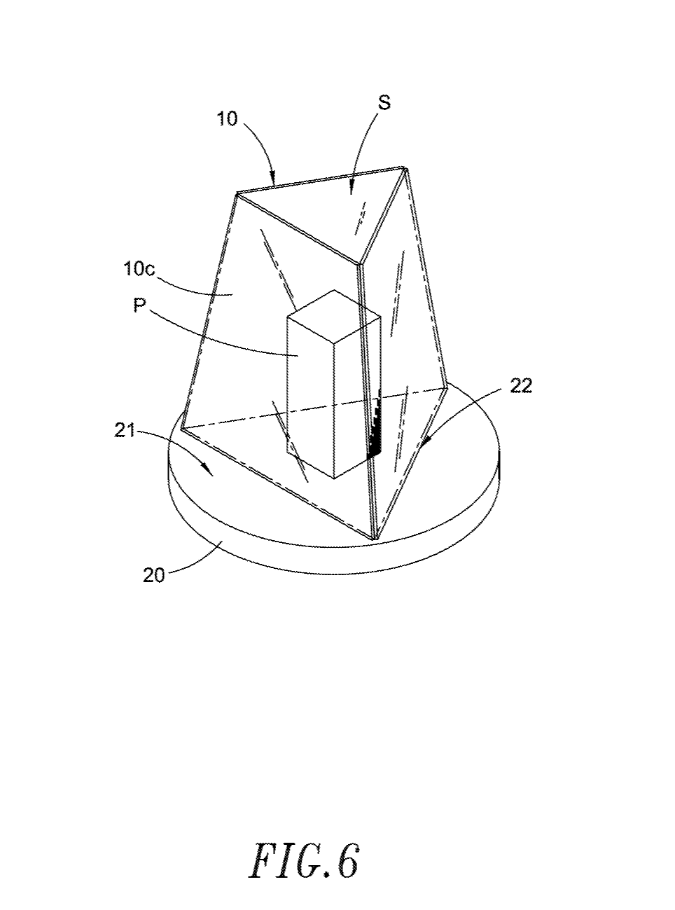

In the embodiment of the present invention, the number of the rendering mediums 10 can be three or more; for example, as shown by the embodiment in FIGS. 3 and 4, five mutually adjoined rendering mediums 10 together constitute a columnar multi-plane presentation medium group. In one embodiment of the present invention, the planar profile of the rendering medium 10 (i.e., the 2-dimensional shape) may be of a rectangle or other type of polygons, such as a trapezoid or a triangle. The multi-plane presentation medium group shown in FIGS. 5 and 6 is of a tapered structure formed by three mutually adjoined trapezoidal rendering mediums 10c, and similarly, it is also possible to use at least three mutually adjoined trapezoidal rendering mediums 10c to form a multi-plane presentation medium group of a polygonal tapered structure. Hence, the multi-plane presentation medium group includes the rendering mediums 10 in multiple planes, so that any single rendering medium 10 can display and conjunctively play the graphical and textual video/audio information on a specific orientation.

As shown in FIGS. 3 and 4, in one embodiment of the present invention, such rendering mediums 10 can be mutually adjoined by means of a connector 30 which can be installed between any two adjacent rendering mediums 10 so as to connect any two adjacent rendering mediums 10. The implementation of the connector 30 may be any one of the hinge as well as the pivot joint axle and the pivot joint seat thereof.

Although the present invention has been disclosed in accordance with the aforementioned embodiments, they are in every aspect not intended to limit the scope of the present invention; any skilled persons in relevant arts can certainly make changes and modifications without departing from the spirits and ranges of the present invention, thus the claimed scopes of the present invention should be considered as being delineated by the appended claims of the present specification.

What is claimed is:

1. A presentation system enabling adjustable photo transmittance and multi-plane visibility, suitable for presenting a physical object and/or the graphical and textual video/audio information of the object in a multi-plane fashion, comprising: at least three rendering mediums having the feature of adjustable photo transmittance, in which such rendering mediums are upright installed and mutually adjoined to constitute a multi-plane presentation medium group having an internal presentation space.

2. The presentation system enabling adjustable photo transmittance and multi-plane visibility according to claim 1, wherein the multi-plane presentation medium group is of a polygonal columnar structure including plural rendering mediums enabling adjustable photo transmittance.

3. The presentation system enabling adjustable photo transmittance and multi-plane visibility according to claim 1, wherein the multi-plane presentation medium group is of a polygonal tapered structure including plural rendering mediums enabling adjustable photo transmittance.

4. The presentation system enabling adjustable photo transmittance and multi-plane visibility according to claim 1, wherein the rendering medium is an active rendering display component enabling adjustable photo transmittance.

5. The presentation system enabling adjustable photo transmittance and multi-plane visibility according to claim 1, wherein the rendering medium is a passive rendering component.

6. The presentation system enabling adjustable photo transmittance and multi-plane visibility according to claim 5, wherein the passive rendering component can be selected to be any one of a combination of the glass and the adjustable photo transmittance material, a combination of the acrylic and the adjustable photo transmittance material as well as a combination of the plastic compound and the adjustable photo transmittance material.

7. The presentation system enabling adjustable photo transmittance and multi-plane visibility according to claim 6, wherein the adjustable photo transmittance material is selected from the electrically conductive switchable transmittance film or the chemical dyestuff object.

8. The presentation system enabling adjustable photo transmittance and multi-plane visibility according to claim 1, wherein a presentation platform is included, which has a load plane for the placement of the object, and the load plane includes a fixation trough corresponding to the bottoms of such rendering mediums constituting the multi-plane presentation medium group, and the fixation trough allows the insertion of the bottom of the rendering medium so as to further facilitate such rendering mediums to be mutually adjoined thus forming the multi-plane presentation medium group.

9. The presentation system enabling adjustable photo transmittance and multi-plane visibility according to claim 1, wherein such rendering mediums are mutually adjoined together by means of a connector installed at the adjoining portions between any two adjacent rendering mediums.

10. The presentation system enabling adjustable photo transmittance and multi-plane visibility according to claim 9, wherein the connector can be any one of the hinge as well as the pivot joint axle and the pivot joint seat thereof.
